(19) United States
(12) Patent Application Publication
(10) Pub. No.: US 2001/0046808 A1
(43) Pub. Date: Nov. 29, 2001

(54) Waterproof contact

(76) Inventors: Martin Bondo Jorgensen, Smorum (DK); Niels Thor Moller, Borup (DK)

Correspondence Address: BIRCH STEWART KOLASCH & BIRCH, PO BOX 747, FALLS CHURCH, VA, 22040-0747, US

(21) Appl. No.: 09/820,164

(22) Filed: Mar. 29, 2001

Related U.S. Application Data
(60) Provisional application No. 60/192,881, filed on Mar. 29, 2000.

(51) Int. Cl. H01R 13/40

(52) U.S. Cl. 439/587

(57) ABSTRACT

A waterproof contact comprising a base plate, a side-wall extending from the base plate in a substantially vertical direction so as to form a housing, said housing having an opening essentially opposite to the base plate. A first and a second outer terminal penetrate the base plate so as to form a first and a second contact area on an inner surface of the base plate. A movable knob is adapted to be moved in a direction substantially perpendicular to a plane defined by the inner surface of the base plate, said knob comprising a bottom part positioned in the housing, a top part positioned outside the housing, and a middle part connecting said bottom and top part and being positioned in the opening of the housing. An electrical conductor is attached to said bottom part for providing electrical contact between said terminals, and the contact comprises sealing means for providing a waterproof seal between said housing and said movable knob.

The present invention relates to a micro-contact resistant to liquid environments. In particular, the present invention relates to a waterproof contact suitable for mounting in hearing instruments.

One of the parameters affecting the lifetime and operability of a hearing instrument is e.g. liquid penetrating the housing of the hearing instrument. Penetration of liquids—e.g. water—into e.g. electrical contacts will typically result in malfunctions of the hearing instrument.

It is an object of the present invention to provide a waterproof contact suitable for mounting in hearing instruments.

The above-mentioned object is complied with by providing a waterproof contact comprising

a base plate,

a side-wall extending from the base plate in a substantially vertical direction so as to form a housing, said housing having an opening essentially opposite to the base plate,

a first and a second outer terminal penetrating the base plate so as to form a first and a second contact area on an inner surface of the base plate,

a movable knob being adapted to be moved in a direction substantially perpendicular to a plane defined by the inner surface of the base plate, the movable knob comprising a bottom part positioned in the housing, a top part positioned outside the housing, and a middle part connecting said bottom and top part, the middle part being positioned in the opening of the housing,

an electrical conductor attached to said bottom part for providing electrical contact between said terminals, and

sealing means for providing a waterproof seal between said housing and said movable knob.

The contact may further comprise a flexible encapsulation enclosing the parts of the movable knob extending outside the housing and the covering part of an upper surface of the housing. The flexible encapsulation may in principle be fabricated from any rubber like material—like e.g. a thermoplastic elastomer.

The waterproof contact may further comprise an elastic member for loading the movable knob in a direction away from the base plate. Preferably, the elastic member comprises a spring positioned between the base plate and the movable knob.

The sealing means may be positioned around the sidewall and/or between the top part of the knob and an upper surface of the housing.

The sealing means may be formed by the above-mentioned thermoplastic elastomer, but in a preferred embodiment, the sealing means comprises annular member, such as an o-ring, positioned around said middle part and between said top part and an upper surface of the housing. Preferably, the top part has a larger circumference than the middle part, so that the o-ring is positioned below the “neck” provided at the location between the middle part and top part of the knob. Thus, the o-ring provides a waterproof tight seal between the housing and the top part.

Preferably, the o-ring is made of a resilient material, such as silicone or rubber.

The o-ring can perform the function of the above-mentioned elastic member in case the thickness of the o-ring is large enough to load the knob in a direction away from the base plate, when the o-ring is positioned between the upper surface of the housing and the top part of the knob. Thus, the contact may comprise the spring or the o-ring or both of them

The electrical conductor may be glued or screwed or welded together with the bottom part of the knob, and the conductor may be formed as a disc or have any other shape for performing the electrical contact between the terminals.

The contact is preferably made for hearing instruments and thus has small dimensions. In a preferred embodiment, the outer diameter of the housing is 1.9 mm and the height of the housing is 1.4 mm.

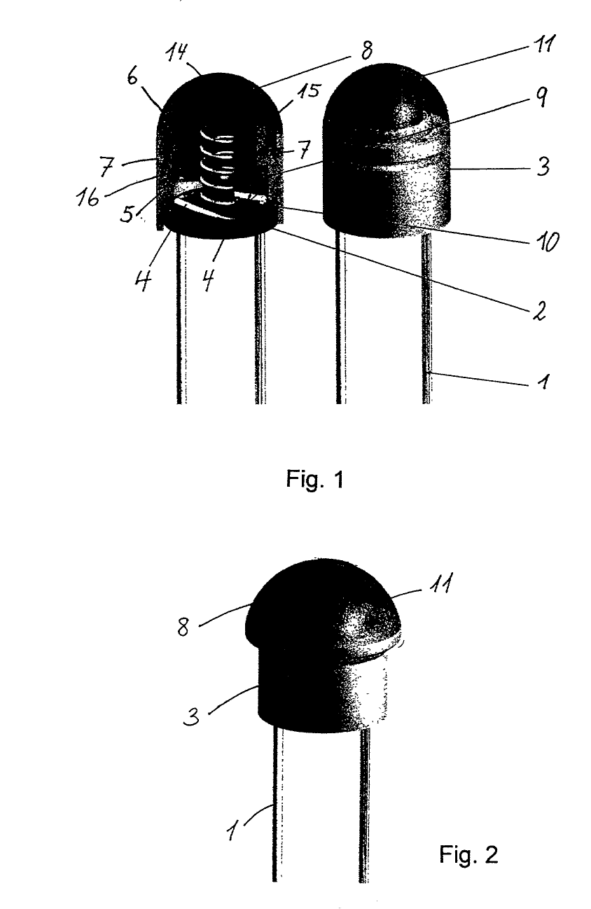

The present invention will now be further described in details with reference to the accompanying FIGS. 1-9 showing views of a waterproof contact according to the present invention.

FIG. 1 shows a waterproof contact in an exploded view and in an assembled view, respectively. FIG. 2 is an alternative embodiment of the one shown in FIG. 1.

The contact has a set of electrically conducting terminals 1. This set of terminals penetrates the base plate 2 in the housing 3 and forms a set of contact areas 4 within the housing. Preferably, the terminals comprise the materials Pd, Ag or Cu or any combination thereof. The base plate 2 is fabricated from a heat resistant material—e.g. polyetheretherketon, and the housing may be fabricated from polyamide and 50% glass.

The base plate 2 of the contact is connected to a sidewall 5 extending in a direction perpendicular to the base plate 2. The sidewall has an opening 6 opposite the base plate 2. The sidewall further comprises inlets 7. The functionality of these inlets will be described later.

The contact further comprises a movable knob 8, which is positioned within the opening opposite the base plate 2. The movable knob 8 is adapted to be moved in a direction perpendicular to the surface of the base plate 2 holding the contact area 4. The top part 14 of the movable knob 8 extends out of the opening, the middle part 15 is positioned in the opening, and the bottom part 16 holds a conductor 9 formed as a disc. Preferably, the disc comprises the materials Ag or Ni or any combination thereof. The movable knob 8 itself is fabricated from a plastic like material—preferably polyoxymethylene (POM).

Preferably, the movable knob 8 is spring-loaded. The spring 10 is positioned between the base plate 2 and the movable knob 8. As long the as contact is not activated the spring 10 holds the movable knob 8 in an upper position away from the base plate 2. The spring 10 is typically fabricated from stainless steel.

By pushing the movable knob 8 towards the base plate 2 the conductor 9 short-circuits the contact areas 4 whereby current can flow between the outer terminals 1.

The extending part of the movable knob 8 is encapsulated in a flexible housing 11. The flexible housing 11 is made of a rubber-like material—e.g. a thermoplastic elastomer. The encapsulation may also cover part of the upper surface defined by the sidewall.

Inlets 7 are used for providing the thermoplastic elastomer during the formation of the encapsulation. At the openings of inlets 7 in sidewall 5 the thermoplastic elastomer preferably forms an o-ring extending all around the sidewall 5. In this way the contact can be inserted into a hole in another object and automatically form a waterproof seal so that water is prevented from penetrating through the hole.

In FIG. 2, the top part with the flexible housing 11 has a larger outer diameter than the housing 3. Between the flexible housing 11 and the housing 3, an o-ring may be provided as described above.

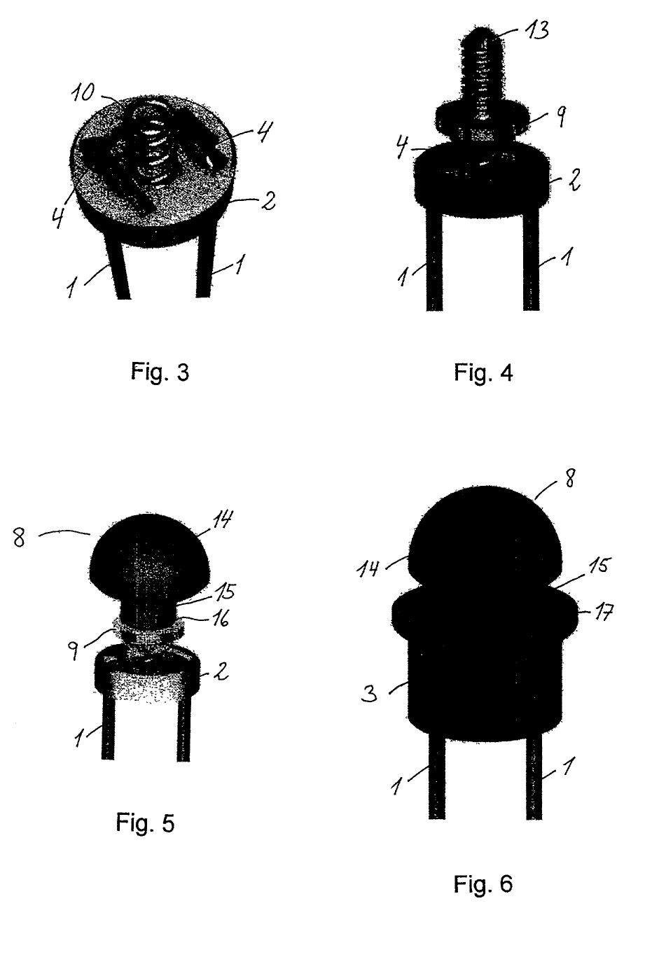

FIGS. 3-6 show views of another embodiment of the waterproof contact according to the invention.

FIG. 3 shows the base plate 2 that is penetrated by two conducting terminals 1 defining the contact areas 4. The spring 10 is adapted to load the knob 8 in a direction away from the base plate 2.

In FIG. 4 an electrical conductor 9 is positioned on the spring 10. The spring extends into the internal part of the rod 13 having an external thread.

In FIG. 5 the movable knob 8 is screwed on to the rod 13. The knob comprises a top part 14, a middle part 15 and a bottom part 16.

In FIG. 6 the housing 3 is positioned around the base plate and extends upwards therefrom for surrounding the electrical conductor (not shown). The housing comprises an upper flange/surface 17.

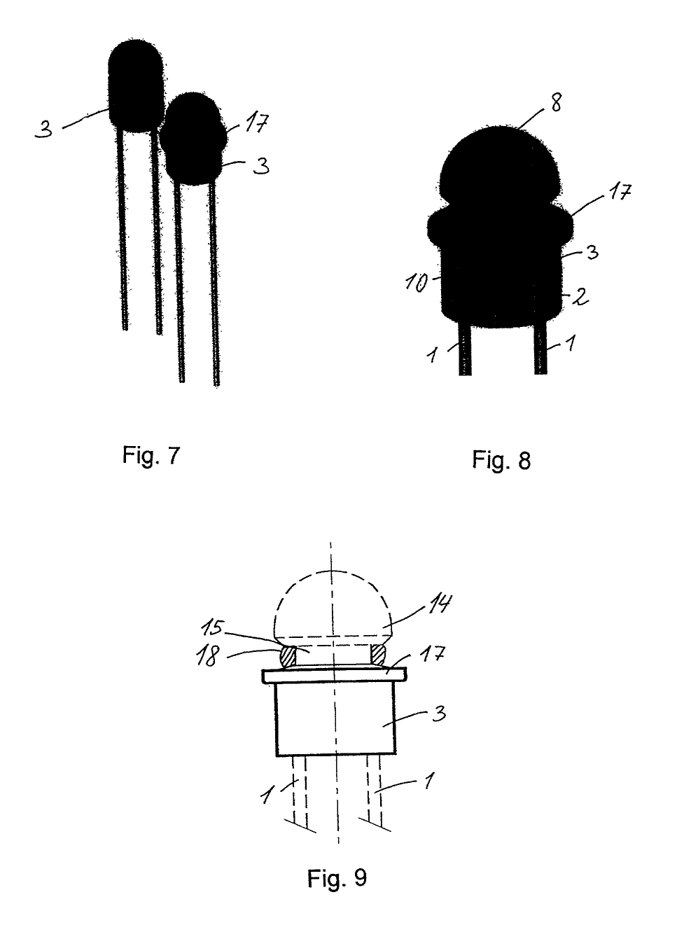

FIG. 7 shows two embodiments of the contact shown in FIGS. 3-6; one having a housing 3 with an upper surface 17 and one having a housing 3 without said upper flange/surface.

FIG. 8 shows the contact in a transparent and assembled view.

FIG. 9 show a contact wherein an o-ring 18 is positioned around the middle part 15 between the top part 14 of the knob 8 and the upper flange/surface 17 of the housing 11. The o-ring provides a waterproof seal between the housing and the knob. Furthermore, the o-ring ensures that the knob is pulled away from the base plate, when the contact is not activated. The o-ring is made of a resilient material, so that it is possible to move the knob downwards and thus compress the o-ring.

1. A waterproof contact comprising
a base plate,
a side-wall extending from the base plate in a substantially vertical direction so as to form a housing, said housing having an opening essentially opposite to the base plate,
a first and a second outer terminal penetrating the base plate so as to form a first and a second contact area on an inner surface of the base plate,
a movable knob being adapted to be moved in a direction substantially perpendicular to a plane defined by the inner surface of the base plate, the movable knob comprising a bottom part positioned in the housing, a top part positioned outside the housing, and a middle part connecting said bottom and top part, the middle part being positioned in the opening of the housing,
an electrical conductor attached to said bottom part for providing electrical contact between said terminals, and
sealing means for providing a waterproof seal between said housing and said movable knob.

2. A waterproof contact according to claim 1, and comprising a flexible encapsulation enclosing the parts of the movable knob extending outside the housing and the covering part of an upper surface of the housing.

3. A waterproof contact according to claim 1, further comprising an elastic member for loading the movable knob in a direction away from the base plate.

4. A waterproof contact according to claim 3, wherein the elastic member comprises a spring positioned between the base plate and the movable knob.

5. A waterproof contact according to claim 2, wherein the flexible encapsulation comprises a thermoplastic elastomer.

6. A waterproof contact according to claim 5, wherein the sealing means is formed by said thermoplastic elastomer.

7. A waterproof contact according to claim 1, wherein the sealing means comprises an annular member positioned around said middle part and between said top part and an upper surface of the housing.

8. A waterproof contact according to claim 7, wherein the annular member comprises an o-ring.

9. A waterproof contact according to claim 8, wherein the o-ring is made of a resilient material, such as silicone or rubber.

10. A waterproof contact according to claim 1, wherein the electrical conductor is glued or screwed together with the bottom part of the knob.

11. A waterproof contact according to claim 1, wherein the electrical conductor is formed as a disc.
